(19) United States
(12) Patent Application Publication
(10) Pub. No.: US 2025/0377440 A1
(43) Pub. Date: Dec. 11, 2025

(54) ANTENNA DEVICE AND RADAR APPARATUS

(71) Applicant: Furuno Electric Co., Ltd., Nishinomiya-City (JP)

(72) Inventor: Kenichi IIO, Nishinomiya (JP)

(73) Assignee: Furuno Electric Co., Ltd., Nishinomiya-City (JP)

(21) Appl. No.: 19/308,372

(22) Filed: Aug. 25, 2025

Related U.S. Application Data
(63) Continuation of application No. PCT/JP2023/031947, filed on Aug. 31, 2023.

(30) Foreign Application Priority Data
Feb. 28, 2023 (JP) 2023-029481

(51) Int. Cl. G01S 7/03; H01Q 21/06

(52) U.S. Cl. CPC G01S 7/03; H01Q 21/065

(57) ABSTRACT

The antenna device comprises a dielectric substrate, a first antenna array including a plurality of patch antennas configured to radiate electromagnetic waves, arranged in the longitudinal direction X, and connected in series on a surface of the dielectric substrate; and a horn member with at least one of a first horn hole and a second horn hole. The electromagnetic waves emitted from the plurality of patch antennas pass through the same hole. A part of the wall surface or the whole of the first horn hole and the second horn hole is made up of conductors. The width in a width direction Y perpendicular to the longitudinal direction X in which the plurality of patch antennas is arranged is greater than the longitudinal direction X.

### CROSS-REFERENCE TO RELATED APPLICATIONS

This application is a bypass continuation application of international application No. PCT/JP2023/031947 having an international filing date of Aug. 31, 2023 and designating the United States, the international application being based upon and claiming the benefit of priority from Japanese Patent Application No. 2023-029481, filed on Feb. 28, 2023, the entire contents of each of which are incorporated herein by reference.

### TECHNICAL FIELD

The present disclosure generally relates to antennas and radars and more particularly relates to a RADAR (Radio Detection and Ranging) apparatus equipped with an antenna device that is capable of improving the directivity of radio waves.

### BACKGROUND

Moving bodies in the marine environment such as vessels, ships, boats, etc. (commonly referred to herein as “vessels”) are typically used for the transportation of people, and goods, among other various applications, across the globe. Sensing apparatuses, such as Radio Detecting and Ranging (RADAR) and Sound Navigation and Ranging (SONAR) systems, are used to identify moving and stationary objects in the marine environment. Such apparatuses transmit electromagnetic (in RADAR) or pressure (in SONAR) waves, sweeping the marine environment for other objects or bodies. The electromagnetic or the pressure waves are reflected from a target object, for example, a target ship or a vessel. The reflected electromagnetic or the pressure waves received by the aforementioned apparatuses are called echoes. The echoes are generally considered as signals carrying information about distance, speed, direction, location, heading, etc. of the target object. Using the echo information, the location, the direction, the translational speed, etc. of the target object can be determined by the concerned apparatuses, such as the RADAR or the SONAR.

In recent years, the development of patch array antennas has been advanced in RADAR systems. A patch antenna is a low-profile antenna that is normally mounted over a larger sheet of metal called a ground plane. The patch antenna is used in the indoor locations covering single-floor offices, stores, and small studios. It is mounted on a small, rectangular, flat surface and consists of two metallic plates placed upon each other.

A Japanese patent document, JP 200988861 A, titled “Horn Array Antenna and Feed Line”, (PTL 1) describes a horn array antenna comprising a plurality of horn antennas, a substrate having a plurality of waveguide grooves for connecting the horn antenna and feed port, respectively, and a back plate having a through-hole that is arranged to adhere closely to the back surface of the substrate and serves as a feed port.
PTL 1: Japanese Patent Application: No.: JP200988861A

In existing patch array antenna systems, the substrate on which the patch array antenna is mounted is very thin. To overcome this, the beam width is widened when warping occurs, but this increases the sidelobe level of the beam. Therefore, a technological need exists for improved RADAR apparatus equipped with an antenna device that is capable of improving the directivity of radio waves.

### SUMMARY

Various embodiments of the present disclosure provide methods and systems for generating a learning model, a program, an information processing method, an information processing device, and an information processing system.

In order to solve the foregoing problem and to provide other advantages, one aspect of the present disclosure is to provide an improved antenna device. The antenna device has a dielectric substrate, a horn member, and a first antenna array. The horn member is provided with at least one of a first horn hole. The first antenna array has a plurality of patch antennas configured to radiate electromagnetic waves passing through the first horn hole, are arranged in a longitudinal direction, and are connected in series on a main surface of the dielectric substrate. The electromagnetic waves emitted from the plurality of patch antennas pass through the first horn hole.

In an aspect, one of a part of a wall surface and the first horn hole is made up of conductors.

In an aspect, a width in a width direction perpendicular to the longitudinal direction in which the patch antennas are arranged is greater than the longitudinal direction.

In an aspect, the width in the width direction extends in the direction of electromagnetic radiation.

In an aspect, the width in the longitudinal direction of the first horn hole is constant.

In an aspect, a ground pattern is formed on the main surface of the dielectric substrate. The conductor of the horn member is in contact with the ground pattern.

In an aspect, a circuit element is implemented on the main surface of the dielectric substrate. The horn member has a recess formed on the surface opposite to the main surface to accommodate the circuit element.

In an aspect, a second antenna array, arranged parallel to the first antenna array, is configured to include the plurality of patch antennas configured to radiate electromagnetic waves, connected in series on the main surface of the dielectric substrate. The horn member further includes at least one of a second horn hole passed the electromagnetic waves emitted from the plurality of patch antennas of the second antenna array.

In an aspect, one of a part of a wall surface and the whole of the second horn hole are made up of conductors.

In an aspect, the second horn hole of the second antenna array is the same shape as the first horn hole of the first antenna array.

In an aspect, a suppression mechanism is configured to suppress electromagnetic wave propagation between the first horn hole and the second horn hole of the horn member.

In an aspect, the suppression mechanism is formed between the first horn hole and the second horn hole of the horn member.

In an aspect, a cover is formed of a dielectric material and closes the first horn hole and the second horn hole.

In an aspect, the cover has a first lens portion at a position corresponding to the first horn hole and a second lens portion at a position corresponding to the second horn hole.

In yet another aspect, a radar apparatus has a transmitter, an antenna, a horn member, a first antenna array, and a receiver. The transmitter is configured to transmit a transmitting signal and the antenna is configured to include a dielectric substrate. The horn member has at least one of a first horn hole. The first antenna array includes a plurality of patch antennas configured to radiate electromagnetic waves of the transmitting signal through the first horn hole, arranged in a longitudinal direction, and connected in series on a main surface of the dielectric substrate. The electromagnetic waves emitted from the plurality of patch antennas pass through the first horn hole.

The receiver is configured to receive a signal reflected at a target.

In an aspect, the radar apparatus has a second antenna array, arranged parallel to the first antenna array, configured to include a plurality of patch antennas configured to radiate electromagnetic waves, connected in series on a main surface of the dielectric substrate. The horn member further includes at least one of a second horn hole passed the electromagnetic waves emitted from the plurality of patch antennas of the second antenna array.

As a result of the various embodiments of the present disclosure, the RADAR apparatus equipped with the antenna device that is capable of improving the directivity of radio waves can be achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings are included to provide a further understanding of the present disclosure and are incorporated in and constitute a part of this specification. The drawings illustrate an exemplary embodiment of the present disclosure and, together with the description, serve to explain the principles of the present disclosure. It should be noted that in the accompanying drawings, like or same reference numerals refer to identical or functionally-similar elements throughout the separate views and which are incorporated in and form a part of the specification, further illustrate the disclosed embodiments and, together with the detailed description of the disclosure, serve to explain the principles of the disclosed embodiments.

The diagrams are for illustration only, which thus is not a limitation of the present disclosure. Moreover, those skilled in the art will understand that the drawings are not to scale.

FIG. 1 is a block diagram showing an example of RADAR apparatus, in accordance with a first embodiment of the present disclosure;

FIG. 2 is an exploded perspective diagram showing an example of an antenna device, in accordance with the first embodiment of the present disclosure;

FIG. 3 is a graph showing simulation results of the directivity of radio waves by the antenna device, in accordance with the first embodiment of the present disclosure;

FIG. 4 is an exploded perspective view showing an example of an antenna device, in accordance with the second embodiment of the present disclosure;

FIG. 5 is a graph showing simulation results of the directivity of radio waves by an antenna device, in accordance with the second embodiment of the present disclosure;

FIG. 6 is an exploded perspective view showing an example of an antenna device, in accordance with the third embodiment of the present disclosure;

FIG. 7 is an exploded perspective view showing an example of an antenna, in accordance with the fourth embodiment of the present disclosure;

FIG. 8 is an exploded perspective view showing an example of an antenna device, in accordance with the fifth embodiment of the present disclosure;

FIG. 9 is an exploded perspective view showing an example of an antenna device, in accordance with the sixth embodiment of the present disclosure; and

FIG. 10 is an exploded perspective view showing an example of an antenna device, in accordance with the seventh embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are outlined in order to provide a thorough understanding of the embodiments of the present disclosure. It will be apparent to those skilled in the art that embodiments of the present disclosure may be practiced without some of these specific details. It should be understood that the particular values and configurations discussed in the following non-limiting examples can be varied and are cited merely to illustrate at least one embodiment and are not intended to limit the scope thereof.

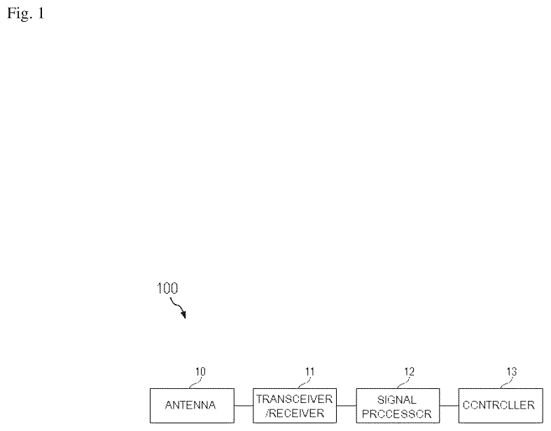

Various embodiments of the present disclosure relate to devices and methods for detecting timing upon receiving a digitally modulated signal. The approach of the present disclosure will be described hereinafter with reference to FIG. 1 to FIG. 10.

The present disclosure discloses an antenna row and a horn member. The antenna row includes a dielectric substrate and a plurality of patch antennas formed on the main surface of the dielectric substrate, arranged in the arranging direction, and connected in series among the first and second directions perpendicular to each other along the main surface. The horn member is fixed on the main surface of the dielectric substrate, a horn hole is formed surrounding the antenna row when viewed in the direction normal to the main surface, and at least the wall surface of the horn hole is formed of a conductor. This makes it possible to improve the directivity of radio waves.

In one embodiment, the width of the horn hole in the arranging direction may be larger than the width in the second direction. This makes it possible to improve the directivity in the second direction as well as the arranging direction in which the patch antennae are arranged.

In one embodiment, the width of the horn hole in the second direction may widen as it moves away from the antenna array. This makes it possible to improve the directivity in the second direction as well as the arranging direction in which the patch antennas are aligned.

In another embodiment, the width of the horn hole in the second direction may be constant. This makes it possible to improve the directivity in the second direction as well as the arranging direction in which the patch antennae are arranged.

In another embodiment, a ground pattern formed on the main surface of the dielectric substrate is further provided, and the conductor of the horn member may contact the ground pattern. This makes it possible to ground the conductor of the horn member.

In another embodiment, a circuit element mounted on the main surface of the dielectric substrate may be further provided, and a recess for housing the circuit element may be formed on the surface of the horn member opposite to the main surface. This makes it possible to protect the circuit elements.

In another embodiment, there is further provided another array of antennas including several patch antennas formed on the main surface of the dielectric substrate, arranged in the arranging direction, and connected in series. In the horn member, there may be further formed another horn hole surrounding the other antenna array when viewed in the normal direction. This makes it possible to improve the directivity of radio waves.

In another embodiment, a propagation suppression mechanism for suppressing the propagation of radio waves may be formed between the horn hole and the other horn hole of the horn member. This makes it possible to suppress the propagation of radio waves between the horn holes.

In another embodiment, a cover formed of a dielectric may be further provided to block the horn holes. This makes it possible to suppress contamination of foreign matter into the horn hole.

In another embodiment, the cover may have a lens at a position corresponding to the horn hole. This makes it possible to further improve the directivity of radio waves.

In another embodiment, an antenna has multiple antenna arrays and horn members. The multiple antenna arrays extend in the arranging direction and are aligned in the second direction among the first and second directions perpendicular to each other along the main surface formed on the main surface of the dielectric substrate. Each antenna array includes multiple patch antennas aligned in the arranging direction and connected in series. The horn member is fixed on the main surface of the dielectric substrate, and when viewed in the normal direction of the main surface, a plurality of horn holes is formed surrounding each of the multiple antenna arrays, and at least the walls of the plurality of horn holes are formed of conductors. This makes it possible to improve the directivity of radio waves.

In another embodiment, the RADAR of the present disclosure comprises the antenna. According to this, it is possible to realize a RADAR apparatus equipped with an antenna device capable of improving the directivity of radio waves.

Embodiments of the disclosure will be described below with reference to the drawings. In this specification and in each figure, elements similar to those described above with respect to the previous figures may be given the same symbols and detailed descriptions may be omitted accordingly.

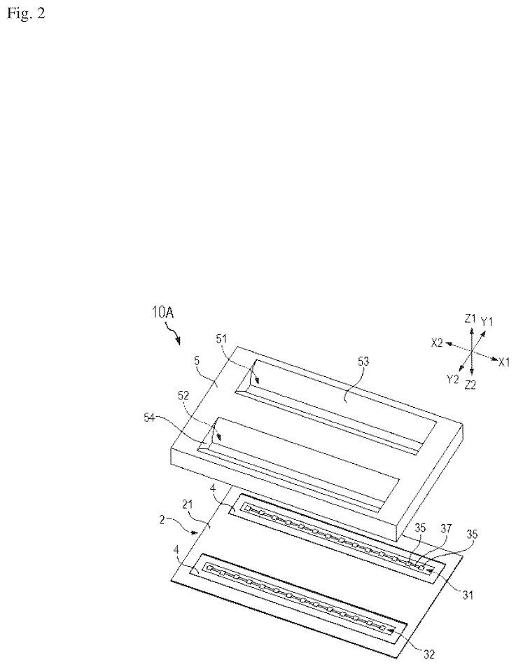

FIG. 1 is a block diagram showing an example configuration of a RADAR 100. The RADAR 100 (also referred to as RADAR apparatus 100) is equipped with an antenna 10 (also referred to as antenna device 10). An “antenna 10” is a general term for the antennas 10A to 10G (also referred to as antennas device 10A, 10B, 10C, 10D, 10E, 10F, 10G) described in FIG. 2 to FIG. 10. The RADAR 100 further includes a transmitter/receiver 11, a signal processor 12 and a controller 13.

The transmitter/receiver 11 includes a modulator and a magnetron, and intermittently drives the magnetron with a pulse voltage generated by the modulator in response to a trigger signal from the signal processor 12 to generate a transmission signal. The antenna 10 transmits the transmission signal from the transmitter/receiver 11 as a radio wave pulse. The transmitter/receiver 11 is configured to receive a signal reflected at a target. While transmitting the signal from the antenna 10, the transmitter/receiver 11 will act as the transmitter 11, while receiving the signal, the transmitter/receiver 11 acts as the receiver 11.

The antenna 10 also converts the received reflected wave into a received signal. The received signal from the antenna 10 is processed by a signal processing section 12 through a frequency conversion/amplification circuit and a detection circuit included in the transmitter/receiver 11 and sent to a controller 13 as a digital signal.

The RADAR 100 is applied to an on-board RADAR for obstacle detection (e.g. target detection) or collision prevention that transmits and receives millimeter waves, for example. Not limited to this, the RADAR 100 may be applied to a marine RADAR that transmits and receives signals for example, microwaves.

FIG. 2 is an exploded perspective view showing an example of an antenna 10A according to the first embodiment. In the following explanation, the direction X1-X2 in FIG. 2 is referred to as the “X direction,” the direction Y1-Y2 is referred to as the “Y direction,” and the direction Z1-Z2 is referred to as the “Z direction.” The Z1 direction is also referred to as the upward direction, and the Z2 direction is referred to as the downward direction. The X direction is an example of the arranging direction or longitudinal direction, and the Y direction is an example of the width direction or second direction.

The antenna 10A has a dielectric substrate 2 formed of a dielectric material. The dielectric substrate 2 has an upper main surface 21 facing upward (the main surface appearing in FIG. 2) and a lower main surface (not shown in FIG. 2) facing downward. The upper main surface 21 is an example of a main surface. The Z direction is the normal direction of the upper main surface 21. The X and Y directions are perpendicular to each other along the upper main surface 21.

The antenna 10A is further provided with a first antenna array 31 (also referred to as first antenna row 31) and a second antenna array 32 (also referred to as second antenna row 32) formed on the upper main surface 21 of the dielectric substrate 2 and multiple ground pattern 4 surrounding each of the first antenna row 31 and the second antenna row 32. The antenna 10A is also further provided with an unillustrated ground pattern 4 that totally covers the lower main surface of the dielectric substrate 2.

The first antenna row 31 and the second antenna row 32 extend in the X direction and are aligned in the Y direction. The X direction is the longitudinal direction of the first antenna row 31 and the second antenna row 32, and the Y direction is the width direction of the first antenna row 31 and the second antenna row 32. For example, the first antenna row 31 is for receiving reflected signal and the second antenna row 32 is for transmitting signal.

The first antenna row 31 and the second antenna row 32 are series-fed patch array antenna and includes a plurality of patch antennas 35 arranged in the X direction and connected in series. Adjacent patch antennas in the plurality of patch antennas 35 are connected by a transmission line 37.

The plurality of patch antennas 35 is rectangular in shape and has a width corresponding to ½ wavelength of the fundamental wave of the frequency used. That is, the width (length in the Y direction) of the plurality of patch antenna 35 is approximately equal to ½ wavelength of the fundamental wave.

The first antenna row 31, the second antenna row 32, and the multiple ground pattern 4 are formed, for example, by patterning a metal foil provided on the upper main surface 21 of the dielectric substrate 2 by a photolithography technique. Therefore, the plurality of patch antenna 35, and the transmission line 37 are integrally formed.

The antenna 10A further includes a horn member 5 that is fixed on the upper main surface 21 of the dielectric substrate 2. The horn member 5 is fixed to the dielectric substrate 2 by fasteners (e.g. screws). The horn member 5 is a flat rectangular solid metal block formed of a conductive metal material (e.g. aluminum).

A first horn hole 51, and a second horn hole 52 (both also called flare holes) penetrating in the Z direction are formed in the horn member 5. The lower ends of the first horn hole 51 and the second horn hole 52 are blocked by a dielectric substrate 2, and the upper ends of the first horn hole 51 and the second horn hole 52 open upward. Each of the first horn hole 51 and the second horn hole 52 has a pair of walls 53 facing in the Y direction and a pair of walls 54 facing in the X direction.

The first horn hole 51 and the second horn hole 52 surround the first antenna row 31 and the second antenna row 32, respectively, when viewed in the Z direction. Specifically, the edges of the lower ends of the first horn hole 51 and the second horn hole 52 surround the first antenna row 31 and the second antenna row 32, respectively, without contacting with the first antenna row 31 and the second antenna row 32. The first horn hole 51 corresponds to the first antenna row 31, and the second horn hole 52 corresponds to the second antenna row 32.

The first horn hole 51 and the second horn hole 52 extend in the X direction and are aligned in the Y direction, as are the first antenna row 31 and the second antenna row 3. That is, the width of the first horn hole 51 and the second horn hole 52 in the X direction is larger than the width in the Y direction. In other words, the spacing of the pair of walls 54 facing in the X direction is larger than the spacing of the pair of walls 53 facing in the Y direction.

In this embodiment, the width of the first horn hole 51 and the second horn hole 52 in the Y direction gradually increases as they move away from the first antenna row 31 and the second antenna row 32, i.e., as they move upward. In other words, the pair of walls 53 facing in the Y direction face obliquely upward. The pair of walls 53 may be a flat surface or a curved surface convex upward.

The lower surface of the horn member 5 is in contact with the multiple ground pattern 4 surrounding the first antenna row 31 and the second antenna row 32. Specifically, the lower edges of the first horn hole 51 and the second horn hole 52 surrounding the first antenna row 31 and the second antenna row 32 in the horn member 5 are in contact with the multiple ground pattern 4. Thus, the horn member 5 is grounded.

It should be noted that the horn member 5 does not necessarily need to be formed entirely of metal material, but at least the pair of walls 53, 54 of the first horn hole 51 and the second horn hole 52 need to be formed of conductors. The first horn hole 51 and the second horn hole 52 may be filled with a dielectric material.

According to this embodiment, by fixing the horn member 5 to the dielectric substrate 2 as a reinforcement, mechanical deformation such as warping can be suppressed and flatness can be maintained, thereby improving the directivity of radio waves without causing problems such as widening the beam width and raising the sidelobe level.

In addition, by fixing the horn member 5 to the dielectric substrate 2 as a reinforcement, the parallelism of the first antenna row 31 for transmission and the second antenna row 32 for reception can be aligned. Furthermore, by arranging the horn member 5 formed of a metallic material, it is also possible to improve heat dissipation.

In addition, the first antenna row 31 and the second antenna row 32 can narrow the beam in the X direction where the plurality of patch antenna 35 is arranged, but by providing the first horn hole 51 and the second horn hole 52 in the first antenna row 31 and the second antenna row 32, it is possible to narrow the beam not only in the X direction but also in the Y direction, which is the width direction of the first antenna row 31 and the second antenna row 32.

Particularly, in this embodiment, the width of the first horn hole 51 and the second horn hole 52 in the Y direction gradually widens as the distance from the first antenna row 31 and the second antenna row 32 increases, so it is possible to narrow the beam more in the Y direction to improve the gain.

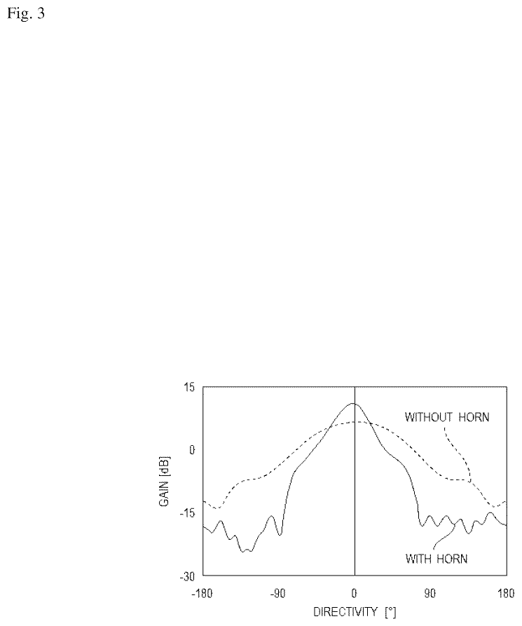

FIG. 3 shows a graph of the simulation results of the directivity of radio waves by antenna 10A according to the first embodiment. The horizontal axis represents the angular range (e.g. directivity) along the Y direction, with zero degrees corresponding to the vertical (upward) direction. The vertical axis represents the gain in decibel (dB).

The solid line in FIG. 3 shows the gain with the horn member 5 and the dashed line shows the gain without the horn member 5. In the simulation, the depth of the horn hole was calculated as 10 mm and the maximum width in the Y direction as 14 mm.

As shown in the FIG. 3, when the antenna 10A has the horn member 5, the beam width of radio waves emitted in the vertical direction (o degrees) is narrower in the Y direction than when the antenna 10A does not have the horn member 5, and the gain is further improved by 5 dB.

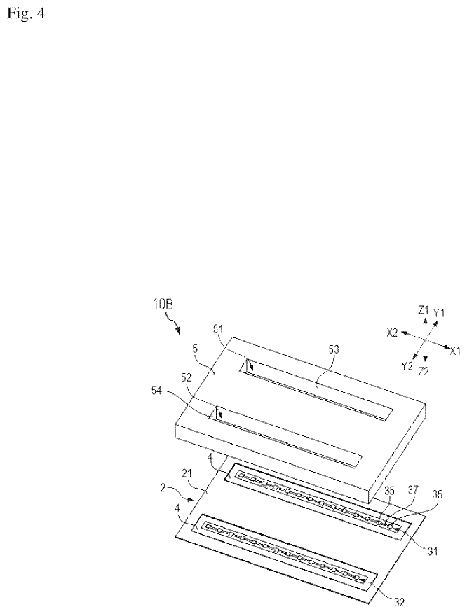

FIG. 4 is an exploded perspective view showing an example of an antenna 10B according to the second embodiment. In this embodiment, the width of the first horn hole 51 and the second horn hole 52 in the Y direction is constant. That is, in other words, the pair of walls 53 facing in the Y direction are vertical or nearly vertical. For processing, a slight taper extending upward or downward may be formed on the pair of walls 53.

According to this embodiment, the area of the first horn hole 51 and the second horn hole 52 on the upper surface of the horn member 5 is minimized, while the width of the first horn hole 51 and the second horn hole 52 in the Y direction is constant. This enables the beam to be narrowed in the Y direction, even if the gain is not expected to improve as much as in the first embodiment above. Furthermore, the degree of freedom of component arrangement and the ease of machining can be improved.

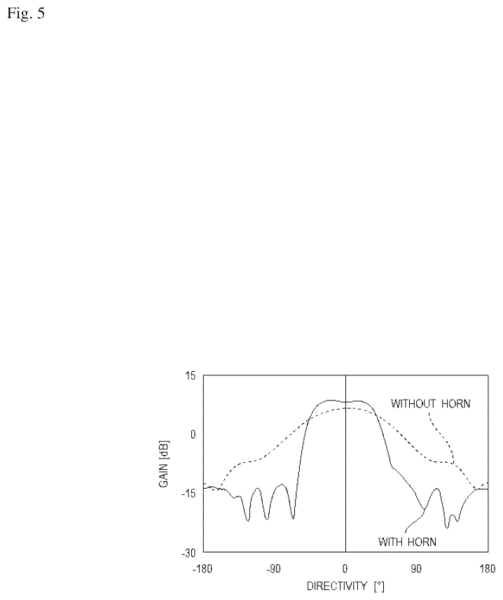

FIG. 5 is a diagram showing the simulation results of the directivity of radio waves by antenna 10B according to the second embodiment. The horizontal axis represents the angular range (e.g. directivity) along the Y direction, and zero degrees corresponds to the vertical direction (upward direction). The vertical axis represents a gain in dB.

The solid line in the FIG. 5 shows gain with the horn member 5 and the dashed line shows gain without the horn member 5. In the simulation, the depth of the horn hole was calculated as 9 mm and the width in the Y direction as 6 mm.

As shown in the FIG. 5, when the horn member 5 is present, the beam width of radio waves emitted in the vertical direction (o degrees) is narrower in the Y direction than when the horn member 5 is absent, and the gain is improved by about 2 dB.

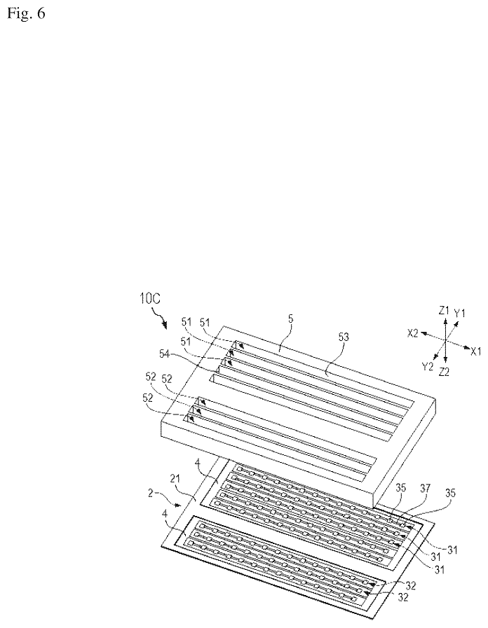

FIG. 6 is an exploded perspective view showing an example of an antenna 10C according to the third embodiment. In the present embodiment, the antenna 10C is equipped with two or more of the first antenna row 31 and two or more of the second antenna row 32 on the upper main surface 21 of the dielectric substrate 2. This makes up the so-called Multi-Input Multi-Output (MIMO) RADAR antenna.

The two or more of the first horn hole 51 corresponding to the two or more of the first antenna row 31 and the two or more of the second antenna row 32 corresponding to the two or more of the second horn hole 52 are formed in the horn member 5. The two or more of the first horn hole 51 surround the two or more of the first antenna row 31 and the two or more of the second horn hole 52 surround the two or more of the second antenna row 32, respectively, when viewed in the Z direction. It should be noted that the two or more of the first antenna row 31 are used for transmission and the two or more of the second antenna row 32 are used for reception. Each of the two or more of the first antenna row 31 represent two or more of the single first antenna row 31 of the first embodiment aligned along the X direction, similarly, each of the two or more of the second antenna row 32 represent two or more of the single second antenna row 32 of the first embodiment aligned along X direction. Further, each of the two or more of the first horn hole 51 represent the two or more of the first horn hole 51 of the first embodiment aligned along the X direction, similarly, each of the two or more of the second horn hole 52 represent the two or more of the second horn hole 52 of first embodiment aligned along the X direction.

That is, the antenna 10C realizes a MIMO RADAR antenna in which the two or more of the first antenna row 31 and the two or more of the second antenna row 32 are provided with the two or more of the first horn hole 51, and the two or more of the second horn hole 52, respectively. This makes it possible to improve the long-range performance and eliminate the interference waves by the multipath.

In this embodiment, as in the second embodiment above, the width of the two or more of the first horn hole 51 and the two or more of the second horn hole 52 in the Y direction is constant, so that the two or more of the first horn hole 51 and the two or more second of the horn hole 52 can be densely packed in accordance with the two or more of the first antenna row 31 and the two or more of the second antenna row 32. Not limited to this, the same two or more of the first horn hole 51 and the two or more of the second horn hole 52 as in the first embodiment above, which widen in the Y direction as they move upward, may be applied (the same applies to the subsequent embodiment).

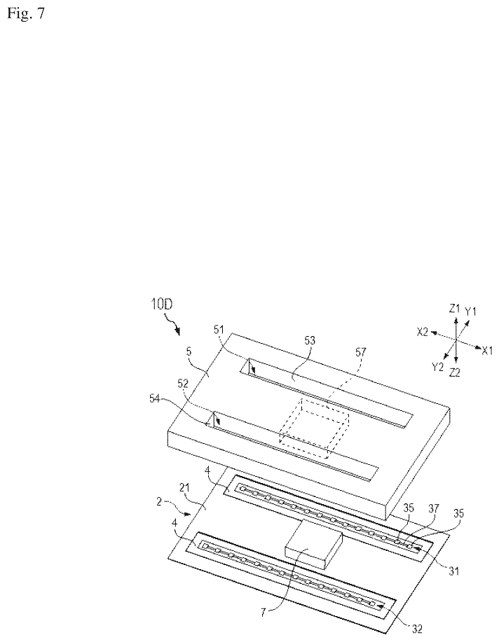

FIG. 7 is an exploded perspective view showing an example of an antenna 10D according to the fourth embodiment. In this embodiment, a circuit element 7 is mounted on the upper main surface 21 of the dielectric substrate 2. The circuit element 7 is, for example, an Integrated Circuit (IC) equipped with a Radio Frequency (RF) circuit.

On the lower surface of the horn member 5 opposite to the upper main surface 21 of the dielectric substrate 2, a recess 57 is formed to accommodate the circuit element 7. When the horn member 5 is fixed to the dielectric substrate 2, the circuit element 7 is accommodated in the recess 57 formed on the lower surface of the horn member 5. It should be noted here that, the circuit element 7 and recess 57 are incorporated in the antenna 10B of the second embodiment to obtain the antenna 10D of the fourth embodiment.

In general, high frequency bands such as 60 GHz and 70 GHZ have problems such as a large loss of the waveguide. Therefore, it is desirable to make the line length between the RF circuit and the antenna as short as possible. On the other hand, if the RF circuit is placed on the same plane as the antenna, protection by a cover is required from the viewpoint of safety.

Therefore, as in this embodiment, the circuit element 7 is mounted on the upper main surface 21 of the dielectric substrate 2, and the horn member 5 is also made to cover the circuit element 7. This makes it possible to shorten the line length between the circuit element 7 and the first antenna row 31 and the second antenna row 32, protect the circuit element 7, and reduce the number of components.

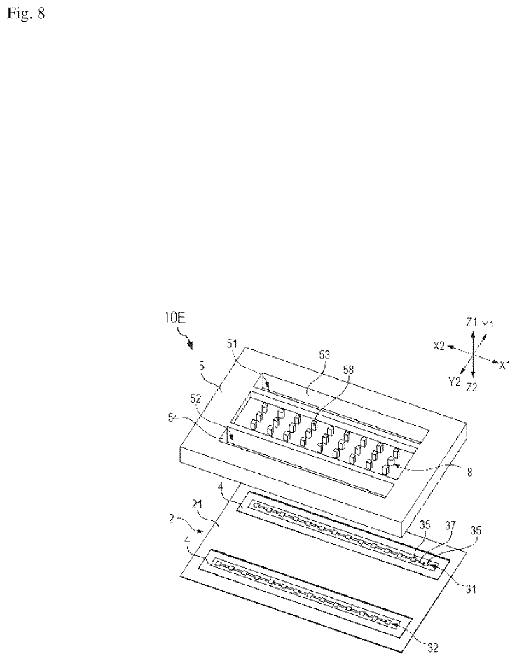

FIG. 8 is an exploded perspective view showing an example of an antenna 10E according to the fifth embodiment. In this embodiment, a propagation suppression mechanism 8 for suppressing the propagation of radio waves is provided between the first horn hole 51 and the second horn hole 52 of the horn member 5. This makes it possible to improve the reception sensitivity by suppressing the propagation of unwanted radio waves from the transmitting antenna row 32 to the receiving the first antenna row 31.

The propagation suppression mechanism 8 is composed of, for example, a plurality of ¼ wavelength lines 58 arranged in a matrix between the first horn hole 51 and the second horn hole 52 on the upper surface of the horn member 5. The plurality of ¼ wavelength lines 58 is a line having a length of ¼ wavelength of the fundamental wave. The plurality of ¼ wavelength lines 58 are formed by cutting the upper surface of the horn member 5.

The propagation suppression mechanism 8 may be, for example, a radio wave absorber located between the first horn hole 51 and the second horn hole 52 of the horn member 5. It should be noted here that, the propagation suppression mechanism 8 is incorporated in the antenna 10B of the second embodiment to obtain the antenna 10E of the fifth embodiment.

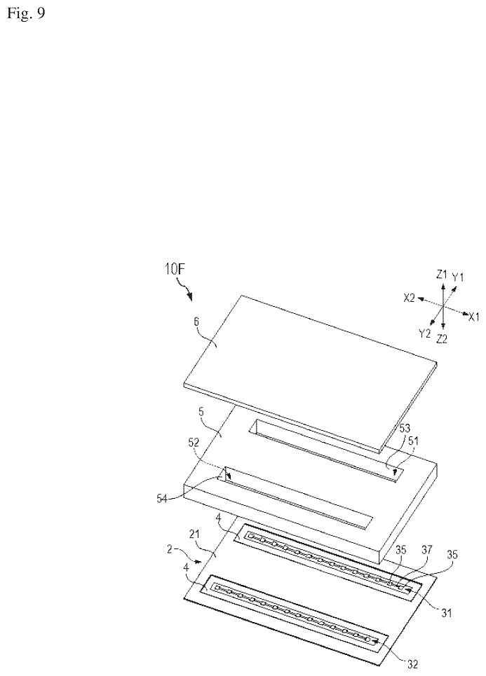

FIG. 9 is an exploded perspective view showing an example of an antenna 10F according to the sixth embodiment. In the present embodiment, the antenna 10F is further provided with a cover 6 formed of a dielectric that closes the first horn hole 51 and the second horn hole 52. This makes it possible to prevent foreign matter from entering the first horn hole 51 and the second horn hole 52.

The cover 6 is formed in a plate shape and arranged on the horn member 5 to block the upper ends of the first horn hole 51 and the second horn hole 52. The cover 6 is fixed to the dielectric substrate 2 by fasteners such as screws together with the horn member 5. The cover 6 is not limited to a plate shape and may be shaped to be inserted into, for example, the first horn hole 51 and the second horn hole 52. It should be noted here that, the cover 6 is incorporated in the antenna 10B of the second embodiment to obtain the antenna 10F of the sixth embodiment.

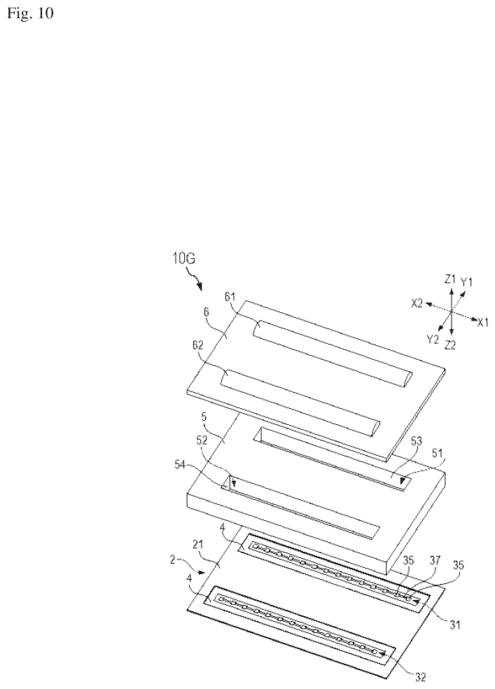

FIG. 10 is an exploded perspective view showing an example of an antenna 10G according to the seventh embodiment. In this embodiment, a first lens portion 61 and a second lens portion 62 are provided at positions corresponding to the first horn hole 51 and the second horn hole 52 of the cover 6. That is, the first lens portion 61 and the second lens portion 62 constitute a dielectric lens. This makes it possible to further improve the directivity of radio waves.

Specifically, the first lens portion 61 and the second lens portion 62 are formed so that the upper surface of the cover 6 rises and constitutes a cylindrical lens convex upward with the X-direction as the axial direction. This makes it possible to narrow the beam more in the Y-direction. A lens part protruding from the lower surface of the cover 6 and inserted into the first horn hole 51 and the second horn hole 52 may be formed. The first lens portion 61 of the cover 6 is at a position corresponding to the plurality of first horn hole 51 and the second lens portion 62 of the cover 6 is at a position corresponding to the plurality of second horn hole 52. It should be noted here that, the cover 6 with the first lens portion 61 and the second lens portion 62 are incorporated in the antenna 10B of the second embodiment to obtain the antenna 10G of the seventh embodiment.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, multiple processors or processor cores, or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, state machine, combination of the same, or the like. A processor can include electrical circuitry configured to process computer-executable instructions. In another embodiment, a processor includes an application-specific integrated circuit (ASIC), a field programmable gate array (FPGA), or other programmable devices that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can”, “could”, “might” or “may”, unless specifically stated otherwise, are otherwise understood within the context as used in general to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z”, unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements, or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations”, without other modifiers, typically means at least two recitations or two or more recitations).

It will be understood by those within the art that, in general, terms used herein, are generally intended as “open” terms (e.g., the term “including” should be interpreted as “including but not limited to”, the term “having” should be interpreted as “having at least”, the term “includes” should be interpreted as “includes but is not limited to”, etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above”, “below”, “bottom”, “top”, “side”, “higher”, “lower”, “upper”, “over”, and “under”, are defined with respect to the horizontal plane.

As used herein, the terms “attached”, “connected”, “mated” and other such relational terms should be construed, unless otherwise noted, to include removable, moveable, fixed, adjustable, and/or releasable connections or attachments. The connections/attachments can include direct connections and/or connections having an intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### LIST OF REFERENCE NUMERALS

100 RADAR
2 dielectric substrate
4 multiple ground pattern
5 horn member
6 cover
7 circuit element
8 suppression mechanism
10, 10A, 10B, 10C, 10D, 10E, 10F, 10G antenna
11 transmitter/receiver
12 signal processor
13 controller
21 upper main surface
31 first antenna row
32 second antenna row
35 plurality of patch antennas
37 transmission line
51 first horn hole
52 second horn hole
53, 54 pair of walls
57 recess
58 plurality of ¼ wavelength lines
61 first lens portion
62 second lens portion
X longitudinal direction
Y width direction
Z normal direction

1. An antenna device comprising:
a dielectric substrate; a horn member with at least one of a first horn hole; and a first antenna array including a plurality of patch antennas configured to radiate electromagnetic waves passing through the first horn hole, arranged in a longitudinal direction X, and connected in series on an upper main surface of the dielectric substrate.

2. The antenna device according to claim 1, wherein:
one of a part of a wall surface and the first horn hole is made up of conductors.

3. The antenna device according to claim 1, wherein:
a width in a width direction Y perpendicular to the longitudinal direction X in which the plurality of patch antennas is arranged is greater than the longitudinal direction X.

4. The antenna device according to claim 3, wherein:
the width in the width direction Y extends in the direction of electromagnetic radiation.

5. The antenna device according to claim 4, wherein:
the width in the longitudinal direction X of the first horn hole is constant.

6. The antenna device according to claim 2, further comprising:
a multiple ground pattern formed on the upper main surface of the dielectric substrate, wherein:
the conductor of the horn member in contact with the multiple ground pattern.

7. The antenna device 10 according to claim 1, further comprising:
a circuit element implemented on the upper main surface of the dielectric substrate, wherein:
the horn member has a recess formed on the surface opposite to the upper main surface to accommodate the circuit element.

8. The antenna device according to claim 1, further comprising:
a second antenna array, arranged parallel to the first antenna array, configured to include the plurality of patch antennas configured to radiate electromagnetic waves, connected in series on the upper main surface of the dielectric substrate, wherein:
the horn member further includes at least one of a second horn hole passed the electromagnetic waves emitted from the plurality of patch antennas of the second antenna array.

9. The antenna device according to claim 8, wherein:
one of a part of a wall surface and the whole of the second horn hole is made up of conductors.

10. The antenna device according to claim 8, wherein:
the second horn hole of the second antenna array is the same shape as the first horn hole of the first antenna array.

11. The antenna device according to claim 8, further comprising:
a suppression mechanism configured to suppress electromagnetic waves propagation between the first horn hole and the second horn hole of the horn member.

12. The antenna device according to claim 11, wherein:
the suppression mechanism is formed between the first horn hole and the second horn hole of the horn member.

13. The antenna device according to claim 8, further comprising:
a cover formed of a dielectric material and closes the first horn hole and the second horn hole.

14. The antenna device according to claim 13, wherein:
the cover has a first lens portion at a position corresponding to the first horn hole and a second lens portion at a position corresponding to the second horn hole.

15. A RADAR apparatus, comprising:
a transmitter configured to transmit a transmitting signal; an antenna configured to include a dielectric substrate; a horn member with at least one of a first horn hole; a first antenna array including a plurality of patch antennas configured to radiate electromagnetic waves of the transmitting signal passing through the first horn hole, arranged in a longitudinal direction X, and connected in series on an upper main surface of the dielectric substrate; and a receiver configured to receive a signal reflected at a target.

16. The RADAR apparatus according to claim 15, further comprising: a second antenna array, arranged parallel to the first antenna array, configured to include the plurality of patch antennas configured to radiate electromagnetic waves, connected in series on the upper main surface of the dielectric substrate, wherein: the horn member further includes at least one of a second horn hole passed the electromagnetic waves emitted from the plurality of patch antennas of the second antenna array.
